(19) United States
(12) Patent Application Publication
(10) Pub. No.: US 2012/0229056 A1
(43) Pub. Date: Sep. 13, 2012

(54) BATTERY PACK WITH SAFETY DEVICE, CONTROL DEVICE AND CONTROL METHOD

(75) Inventor: Thomas Bergfjord, Halmby (SE)

(73) Assignee: ELECTROENGINE IN SWEDEN AB, Uppsala (SE)

(21) Appl. No.: 13/393,372

(22) PCT Filed: Aug. 31, 2010
(86) PCT No.: PCT/SE10/50929

§ 371 Date: May 17, 2012

(30) Foreign Application Priority Data
Sep. 1, 2009 (SE) 0901103-2

(51) Int. Cl. H02J 7/00; H02P 21/00

(52) U.S. Cl. 318/139; 320/135

(57) ABSTRACT

A battery pack (33) includes at least one battery cell (39), and is designed to supply an output voltage for feeding electric energy to a load (23) so that the load may perform a function. A battery control device (35) arranged to generate control signals for controlling a battery pack, a device (21) including a battery pack, and a method for controlling a battery pack are also described.

### TECHNICAL FIELD

The present invention relates to a battery pack, a battery control device for a battery pack, a device comprising a battery control device and a battery pack, and a method for controlling a battery pack.

### PRIOR ART

Battery packs comprising one or more battery cells for providing energy to electric devices that are unsuited to be connected with a stationary power grid during their operation are known in the art. Examples of electrical devices powered by battery packs include electric vehicles, mobile phones, electric tools, work machines and others. Battery packs may also be used for grid balancing and other forms of energy storage. One problem with battery packs having many battery cells connected in series is that the voltage may be very high, so that the high voltage becomes a hazard to people or equipment, in particular in case of an emergency or a malfunction.

One method of overcoming =this problem is shown in patent document U.S. Pat. No. 5,238,083, showing a battery pack for vehicles comprising switches that disconnects two battery cells from each other upon detection of a collision by a collision sensor. Hence, in case of an accident the voltage supplied by the battery pack is reduced to decrease the risk of damages.

Another method of overcoming this problem is shown in patent document US 2004/0257033, showing a casing enclosing a battery, which casing is provided with a switch that shuts off the connection out of the casing when the casing is removed from its position in the vehicle. Hence there is less risk of electric shocks while handling the casing containing the battery.

In patent document US 2005/0275372 a method for protecting battery packs from overload is shown, in which a plurality of smart battery packs are connected in parallel, and are switched into serial connection for feeding a device only in case a sufficient number of battery packs are sufficiently charged, and with sufficiently similar charges, to be able to feed the device. This document does not however address the problem of risks with high voltages.

### SUMMARY OF THE INVENTION

One object of the present invention is to alleviate the problems of high risks in conjunction with using high voltages for devices powered by a battery pack.

According to a first aspect of the invention this object is achieved with a battery pack according to claim 1.

According to a second aspect of the invention this object is achieved with a battery control device according to claim 9.

According to a third aspect of the invention this object is achieved with a device according to claim 14.

According to a fourth aspect of the invention this object is achieved with a method according to claim 16.

By providing a battery pack comprising at least one battery cell and a battery control circuit adapted to receive an operate control signal indicating that a load is to perform its function, and to allow feeding the supply of voltage from the battery cell through the battery control circuit in response to the operate control signal, it is possible to supply the voltage through the battery control circuit primarily when the load is in actual operation. Hence the time during which voltage is supplied through the battery control circuit can be limited, decreasing the risk of high voltages.

Preferably, the battery control circuit also avoids feeding the supplied voltage through the battery control circuit in response to receiving information that the load is in a non-operating state. Preferably, the reception of information that the load is in a non-operating state also encompass an absence of a signal that the load is in an operating state. Hence in case the load is not actively performing its function, the voltage supplied through the battery control circuit may be decreased or cut-off entirely, decreasing the time during which a high voltage is supplied and substantially improving the safety of using the battery pack.

A device comprising a load is normally in a passive, turned off, state if not fed with electric energy. A device comprising a load may however be fed with electric energy in an active, turned on, state, even though the load is in a non-operational state. Normally, the voltage needed to keep the device in the active state, for example to activate control circuits, lights, etc. is lower than the energy to drive the load to perform its function. Accordingly, it is preferred that the battery control device avoids generating the operate control signal and that the battery control circuit avoids feeding the supplied voltage through the battery control circuit in an active state of the device until the load is actually operated. The device may then include an auxiliary battery for powering the device in the active state, or electric energy with lower voltage may be received from a smaller part of the battery pack. Examples of devices that may be turned on in anticipation of a load performing a high-energy consuming function include mobile phones, electric tools, and electric vehicles.

According to one embodiment of the invention the battery control circuit is arranged to avoid feeding the supplied voltage through the battery control circuit in the event of an absence of the operate control signal. Preferably, the battery control device is similarly adapted to avoid generating an operate signal in response to receiving information that the load is in a non-operating state. Since the generation of an operate control signal then requires an activity by the battery control device this means that the voltage is more likely to be decreased or cut-off in the battery control circuit due to a non-operative state and/or in case of a malfunction. Preferably the battery control circuit is arranged to avoid feeding the supplied voltage through the battery control circuit in the event of an absence of an operate control signal specifically indicating an operation of the load. Hence, as soon as the load is non-operational, or the operate control signal ceases for any other reason, the battery control circuit strives to cut off any voltage supply through the battery control circuit. Hence the supply and/or presence of a high voltage can be limited to times of actual operation of the load only. Preferably, the battery control device is arranged to generate the operate control signal continuously during actual operation of the load, and the battery control circuit is arranged to allow the supply of voltage through the battery control circuit while receiving the operate control signal. Hence a prolonged operation of the load is allowed while retaining a high safety. Preferably, as soon as the operation is interrupted, the operate control signal is discontinued and the battery control circuit cuts-off the supply of voltage through the battery control circuit.

According to one embodiment of the invention the battery control circuit comprises a semi-conductor device comprising a first connector electrically connected with at least one battery cell, a second connector, and a switch control arranged to allow a current between the first and the second connectors when receiving a control voltage. Preferably the control voltage is received from the operate control signal. Preferably the semi-conductor device is a FET-device, such as a MOS-FET, or an IGBT. Such devices are naturally cut-off unless receiving a voltage signal at the gate. Thus the features of the invention may be achieved easily and inexpensively by use of the semiconductor device.

According to one embodiment of the invention the battery control circuit comprises a semi-conductor switch. Preferably the battery control circuit is an on/off-switch. Thus the battery control circuit may be in a cut-off state in which the battery control circuit avoids feeding the voltage and a conducting state in which the battery control circuit feeds the voltage while striving for reducing the resistance and/or voltage drop over the battery control circuit. The semi-conductor switch may also be arranged as a FET, such as a MOS-FET, IGBT, or any other form of known or future semiconductor switches.

According to one embodiment of the invention the device containing the battery pack and the battery control device is an electric vehicle. The battery pack is thus adapted to supply electric energy to the electric vehicle and to the load, wherein the load is an electric motor for propulsion of the vehicle. The battery control device is further arranged to generate the operate control signal in response to the electric motor being induced to propulse the vehicle. The electric motor may be induced to propulse the vehicle from a driver depressing an accelerator, from an electronic speed regulator such as a cruise control, or similar. Feeding of the supplied voltage through the battery control circuits is thus allowed upon detection of a drive signal.

Preferably, unless a signal is received that there is a desire to operate the motor to propulse the vehicle no voltage is allowed to be supplied through the battery control circuit. Preferably the battery control circuit is arranged to separate the battery pack into separate groups of battery cells. Preferably each group of cells is arranged to supply a voltage less than or equal to 60 V, preferably less than 50 V. Preferably, the separate groups may furthermore be connected in series through the battery control circuits. Thus the maximum voltage in the vehicle is 60 V at all times except when actually providing propulsion to the vehicle, wherein the voltage may be raised to a voltage suitable for the electric motor driving the vehicle such as between 400-600 V.

### BRIEF DESCRIPTION OF THE ATTACHED DRAWINGS

The invention is now to be described as a number of non-limiting examples of the invention with reference to the attached drawings.

FIG. 1 shows a battery pack comprising a single battery cell provided with a single battery control circuit.

FIG. 2a shows a device in the form of a vehicle comprising a battery pack, and a battery control device.

FIG. 2b shows a circuit diagram of the battery pack in the vehicle.

FIG. 2c shows a diagram of the device comprising the battery pack, the battery control circuit and the load.

FIG. 3 shows a method according to the invention.

### DETAILED DESCRIPTION

In FIG. 1 a battery pack 1 comprising at least one battery cell 3 is shown. The battery cell comprises a body 5 containing chemicals for storing electric energy and for generation of a voltage through chemical reaction. The battery cell 3 further comprises a first 7 and a second 9 battery pole for supplying the generated voltage to external circuits and ultimately to a load. The battery pack 1 further comprises a battery control circuit 11 connected with one pole of the battery cell, and arranged to be able to either feed, or avoid feeding, the voltage supplied by the battery cell 3 through the battery control circuit 11.

In this example the battery control circuit 11 comprises a semi-conductor device comprising a first connector 13 electrically connected with the first pole 7 of the battery cell, a second connector 15 arranged to supply the voltage to an external circuit including a load, and a switch control 17. The semi-conductor device is in this example a FET, or field-effect transistor, and may be a MOS-FET, an IGBT or any other suitable field-effect transistor. The switch control 17 is thus arranged to allow a current between the first 13 and the second 15 connectors when a voltage above a threshold is applied onto the switch control, and to cut-off any current between the first and the second connectors in the absence of an applied voltage.

According to one aspect of the invention the battery control circuit 11 is adapted to receive an operate control signal indicating that a load is to perform its function, and to allow feeding the supply of voltage through the battery control circuit 11 in response to the operate control signal. In this example the operate control signal is received from a battery control device as a voltage applied onto the switch control. Hence the battery control circuit 11 is adapted to allow feeding the supply of voltage from the battery cell 3 through the battery control circuit 11 in response to continuously receiving the operate control signal. Since the switch control 17 furthermore avoids feeding a supplied voltage from the battery cell through the battery control circuit in the absence of a voltage applied on the gate, a voltage is supplied by the battery pack almost exclusively while receiving the operate control signal, that is, while the load is in operation. Hence the safety of the battery pack is improved, since the voltage is only supplied when it is necessary.

The first connector 13 of the battery control circuit is in this example designed to cover a part of the first pole 7, leaving a small area of the first pole 7 open. Hence, a voltage may be extracted from the open area of the first pole 7 even if an operate control signal is not received. The open area of the pole may then be used for supplying voltage to and powering other parts of a device, such as the battery control device, lights or others. In another example the first connector may instead cover the entire area of the first pole of the battery cell, wherein a voltage cannot be extracted from the battery cell without passing the supplied voltage through the battery control circuit.

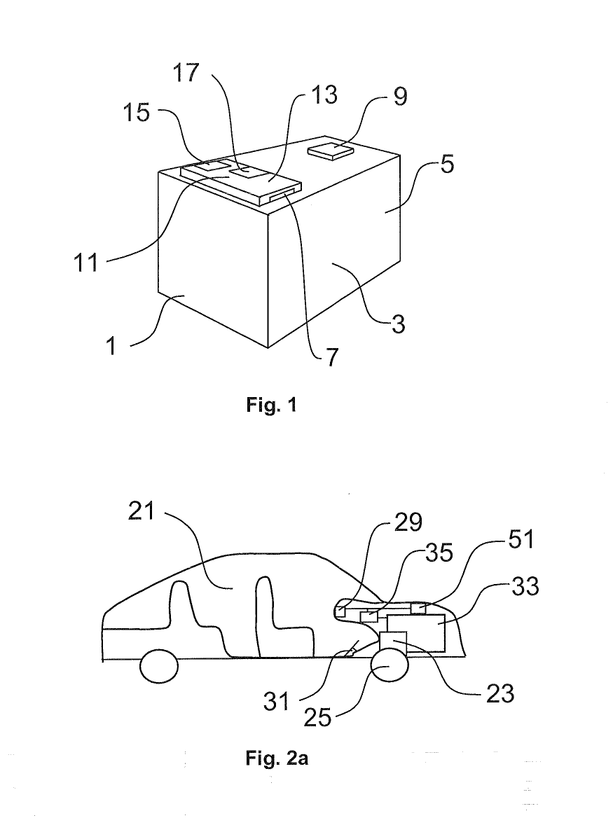

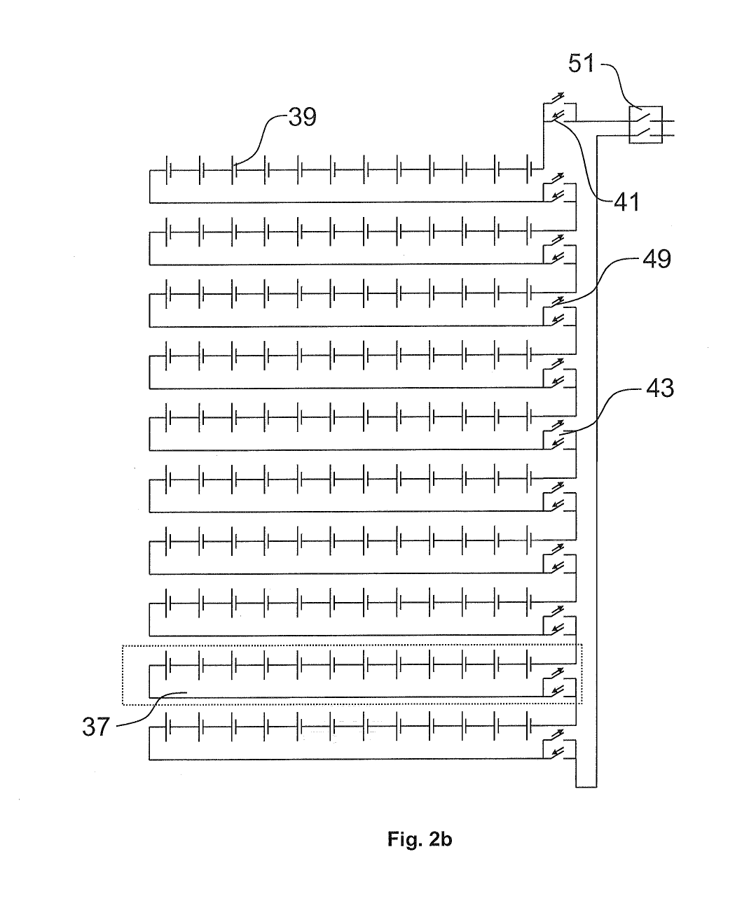

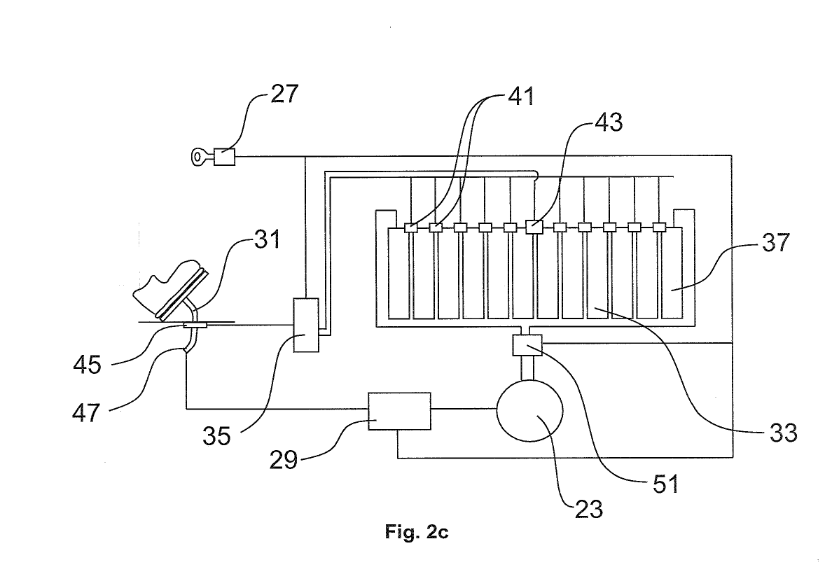

In FIG. 2a-c another embodiment according to one example of the invention is shown. FIG. 2a shows a device 21 comprising an electric load 23 arranged to perform a function. The device is in this example an electric vehicle 21, wherein the load 23 is an electric motor arranged to provide propulsion for the vehicle, and is thus connected to a drive wheel 25. The load 23 is hence arranged to perform work, in this example mechanical work, in an operating state.

The device further comprises a main switch control 27 for turning the device on or off, that is, for switching the device 21 between a passive state, in which the device is turned off and almost no power is supplied to the vehicle, and an active state, in which the device 21 is turned on, control circuits are powered and the vehicle may or may not be moving. The main switch control 27 of the vehicle may be actuated by a user, for example by turning a key, in order to switch the device 29 between the active and passive states. The device 21 also comprises a control device 29 for controlling the operation of the load 23, and an actuator 31, in this example in the form of an accelerator comprising a pedal, adapted to be actuated by a user and for generating a signal of desired acceleration to the control device. The control device 29 controls the electric motor 23 to provide propulsion to the vehicle in an active, operating state, or to refrain from providing propulsion to the vehicle in an active, non-operating state, based on the input from the actuator 31.

The device 21 further comprises a battery pack 33 for powering the load, and a battery control device 35 for controlling the battery pack. In FIGS. 2b and 2c the battery pack 31 is shown to comprise twelve groups 37 of twelve battery cells 39 each. The battery cells 39 in each group are connected in series and the groups 37 themselves are also connected in series. In this example, the battery cells 39 comprises Li-ion batteries, wherein the average voltage of each group is about 48 V and the average voltage of the battery pack 33 as a whole is about 576 V.

The battery pack further comprises at least three electrically separate groups 37 of the at least one battery cells, and at least a first 41 and a second 43 battery control circuit, each connected between different groups of battery cells. In this example the battery pack comprises eleven battery control circuits 41, 43, similar in function to the battery control circuit described in relation to FIG. 1. Each battery control circuit 41, 43 is connected to one group 37 of battery cells, and is also connected between two groups 37 of battery cells so as to divide and electrically separate the groups 37 of batteries into the twelve groups in the battery pack 33. Hence, the battery pack 33 will be electrically separated into groups, so that the maximum voltage supplied by the battery pack 33 in a non-operating state for the load 23 is the maximum voltage of the groups, in this example less than or equal to 60 V, preferably less than or equal to 50 V, in this example about 48 V. Preferably, the maximum voltage of the groups follow possible voltage regulations, so as to be below any legal limits set in order for an amateur to be allowed to work with the electrical system.

In this example the actuator 31 comprises an accelerator pedal, and a first sensor 45 sensing any depression of the accelerator pedal. The first sensor 45 further generates a signal to the battery control device 35 in response to the sensed depression, containing information that there is a desire to provide propulsion to the load 23. The battery control device 35 is then adapted to generate an operate control signal to the battery control circuits 41, 43 in response to the information. The battery control device 35 is thus arranged to generate the operate control signal in response to the electric motor being induced to propulse the vehicle. The battery control device 35 is also arranged to continuously generate the operate control signal while the load 23 is being operated. The battery control device 23 is arranged to generate the operate control signal by supplying a control voltage to the at least one battery control circuit.

The battery control circuits 41, 43 are arranged to allow feeding a supply of voltage through the battery control circuits 41, 43 in response to the operate control signal. Hence, the battery control circuits 41, 43 electrically connect the groups 37 of battery cells 39 by allowing a feeding of the supplied voltage through the battery control circuits 41, 43 in response to the operate control signal. In this example the battery control circuits 41, 43 connects the groups of battery cells in series to provide a higher voltage. Hence the battery pack 33 will in this example almost only supply a high voltage while the electric motor 23 actually drives the vehicle and performs work. The battery control circuit 41, 43 is further arranged to avoid feeding the supplied voltage through the battery control circuit in the event of an absence of the operate control signal. The battery pack 33 may thus remain in a safe, disconnected state even when the vehicle is moving, in case the electric motor 23 does not need to generate any work at that time.

In this example the battery pack 33 comprises ten battery control circuits of a first kind 41 having the ability to withstand a lower voltage and/or current during the switching between a conducting and non-conductive state. The battery pack further comprises a second kind of battery control circuit 43 designed to withstand a higher voltage and/or current during the switching between a conducting and non-conductive state than the first battery control circuit. The battery control device 29 is arranged to first generate an operate control signal to the first battery control circuits 41 and then to generate a second operate control signal to the second battery control circuit 43.

When connecting the groups of battery cells in series through the battery control circuits for supplying the higher voltage the instantaneous voltage supplied by the battery pack increases for each additional group connected. By providing the operate control signal to a first, weaker kind of battery control circuits 41 in a first step, and to a second, tougher battery control circuit 43 in a following step, the voltage is applied after a circuit has been closed, wherein the first battery control circuits need not be able to withstand the higher voltage. Hence the cost of the first battery control circuits may be reduced. The second battery control circuit 43, however, needs to be able to withstand the high voltage of the joint battery pack.

The battery control device 29 is further arranged to first avoid generating the second operate control signal to the second battery control circuit 43, and then to avoid generating the operate control signal to the first battery control circuits 41. Hence the second battery control circuit 43 will open the closed circuit through the battery pack so that the voltage and the current are cut. In this example the second battery control circuit 43 is also capable of disrupting a current flowing through the battery control circuit 43, which current is driven by the high voltage from the joint battery pack. The first battery control circuits, however, need not necessarily be able to cut the current, since they may rely on that the current is cut by the second battery control circuit before the first battery control circuits are switched off. Both the first and the second battery control circuits must however be able to withstand the current flowing during operation without breaking.

In this example the second battery control circuit 43 is further positioned in the middle of the battery pack. Thus the voltage applied over the second, lastly connected, battery control circuit is almost halved in comparison to if the second battery control circuit would be positioned at the end of the battery pack.

In this example the actuator comprises a second sensor 47 adapted to generate a drive signal to the control device 29 in response to actuation of the pedal by a driver. The second sensor 47 is arranged to provide information of magnitude with the drive signal, so that the control device 29 may order a desired acceleration from the load.

The first sensor 45 and the battery control device 35 is furthermore operating with a clock frequency which is at least equal to, but preferably higher than, the clock frequency of the second sensor and/or the control device 29. The first sensor 45 and the battery control device 35 is furthermore operating with a clock frequency which is at least equal to or higher than 12 000 Hz, preferably 15 000 Hz. In this example the second sensor 47 and the control device 29 operate with a clock frequency of 10 000 Hz, while the first sensor 45 and the battery control device operate with a clock frequency of 20 000 Hz. Hence it is ensured that the battery control device 35 controls the battery pack 33 to supply the higher voltage a short time before the load 23 is to be operated. Otherwise the load might have been controlled to perform work while not receiving power from the battery pack. Furthermore, the high frequency ensures that in the event of an error or a discontinuation of the use of the load, the high voltage is cut within a very short time.

Each battery control circuit 41, 43 is in this example further provided with a second switch 49 or controllable circuit for providing a backward current to the battery pack 33 in order to allow charging of the battery cells 39. In this example the second switch 49 is further provided with a diode to obstruct conduction in the forward direction. The second switch 49 may be controlled by the battery control device 35, or alternatively by a charging control device. In case of a vehicle, the second switch 49 may allow for regenerative braking.

The battery pack 33 further comprises a main switch 51 arranged to cut-off or allow feeding of a voltage from the battery pack 31 as a whole. The main switch 51 is arranged to receive a signal from the main switch control 27, to allow feeding a current in the active state of the device and to cut-off the current in the passive state of the device 23. The main switch also comprises a switch for allowing charging of the battery pack, for example in the passive state and/or in the active state by regenerative braking.

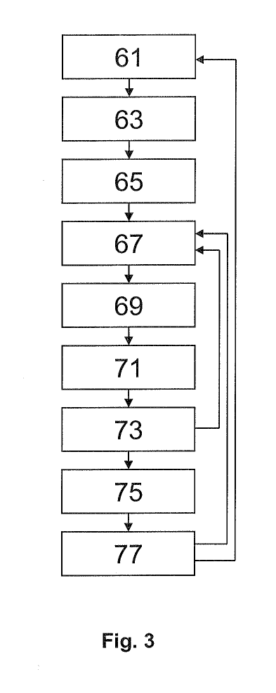

In FIG. 3 one example of a method for controlling a battery pack arranged in an electric vehicle is shown.

In a first, passive state 61 the vehicle is turned off. In the passive state the vehicle is mostly unpowered apart from possible start-up, locking and alarm circuitry. Furthermore, the method comprises avoiding feeding a voltage supplied by at least one battery cell in a battery pack through a battery control circuit. In this example the method further comprises electrically separating the battery pack into at least two groups of at least one battery cell each, wherein the maximum voltage supplied by the battery pack is decreased, so that the safety of the vehicle is improved.

In an activation step 63 the method comprises receiving an instruction from a user to induce the vehicle into an active state. The instruction may be given by the driver using a key-card, turning a key, or performing any other known action for activating the vehicle.

In a second, active state 65 the vehicle is powered, wherein control circuits, lights, sensors, climate system and similar auxiliary components are powered by low-voltage auxiliary power. Furthermore, the vehicle is ready to begin driving and/or may also be moving in a non-accelerating manner. In the second, active but non-operating state 65, the method according to one aspect of the invention still comprises avoiding feeding the voltage supplied by the at least one battery cell through the battery control circuit and associated separation of the battery pack into groups of battery cells.

In a driving step 67 the driver indicates a desired acceleration and/or powering of the electric motor by depressing an acceleration pedal associated with an acceleration actuator. The method comprises sensing the indication with a first sensor, and generating a signal that acceleration and/or powering is desired to a battery control device.

In a battery control step 69 the battery control device generates an operate control signal and transmits the operate control signal to the battery control circuit. The method further comprises allowing feeding the voltage supplied by the at least one battery cell through the battery control circuit in response to receiving the operate control signal. The method further comprises connecting the groups of battery cells with each other in series, in order to form a unified battery pack for supplying a higher voltage. The method further comprises continuously allowing the supply of voltage through the battery control circuit while continuously receiving the operate control signal.

In a motor control step 71 the method comprise sensing the magnitude of depression of the acceleration pedal with a second sensor, and controlling the electric motor with a control device by generating control currents to the motor in response to the depression. The electric motor then provides propulsion to the vehicle by rotating a drive wheel. Since the battery cells in the battery pack are now connected, for example in series, the voltage and power output is sufficient to power the electric motor.

In a rolling step 73 the driver releases the depression of the acceleration pedal but without or before braking, wherein the vehicle may continue to roll due to built-up kinetic energy and/or due to a down-hill stretch of road. The method then comprises interrupting the generation of the operate control signal by the battery control device, alternatively by generation of a non-operation signal, and avoiding feeding the supplied voltage through the battery control circuit in response to the interruption or non-operation signal. Hence the groups of battery cells in the battery pack are once again disconnected to decrease the maximum voltage present in the vehicle.

In a braking step 75 the driver depresses a braking pedal, alternatively induces the vehicle to perform automatic braking, simulating motor braking for a combustion vehicle. The method then comprises generating a braking signal to the battery control circuits, and allowing a backward current to the battery pack through the battery control circuits in response to the braking signal. Hence the battery pack may be recharged by a regenerated current generated by the electric motor, wherein the motor converts built-up kinetic energy into electric energy.

In a following non-moving state 77, the vehicle has come to a full stop. The driver may now choose to continue driving by accelerating the vehicle, or to turn the vehicle off, back into the passive state, by actuation of the main switch control.

The invention is not limited to the embodiments and examples shown above, but may be varied freely by a man skilled in the art within the framework of the following claims. In particular the different features of the examples may be freely interchanged with each other so as to form new examples and embodiments. Also, the invention may be useful in many different areas of applications in order to increase the safety of an electric system.

1. A battery pack (1, 33) comprising at least one battery cell (3, 39), and being designed to supply an output voltage for feeding electric energy to a load (23) so that the load may perform a function, the battery pack further comprising a battery control circuit (11, 41, 43) connected with at least one battery cell and arranged to be able to avoid feeding the voltage supplied by the at least one battery cell through the battery control circuit, characterized in that the battery control circuit (11, 41, 43) is adapted to receive an operate control signal indicating that the load (23) is to perform its function, and to allow feeding the supply of voltage through the battery control circuit (11,41,43) in response to the operate control signal.

2. A battery pack according to claim 1, characterized in that the battery control circuit (11, 41, 43) is arranged to avoid feeding the supplied voltage through the battery control circuit in the event of an absence of the operate control signal.

3. A battery pack according to claim 1, characterized in that the battery control circuit (11) comprises a semi-conductor device comprising a first connector (13) electrically connected with at least one battery cell, a second connector (15), and a switch control (17) arranged to allow a current between the first and the second connectors when receiving a control voltage from the operate control signal.

4. A battery pack according to claim 1, characterized in that the battery pack (33) comprises at least two battery cells (39), and at least one battery control circuit (41, 43) connected between two electrically separate groups (37) of battery cells.

5. A battery pack according to claim 4, characterized in that the battery pack (33) comprises at least three electrically separate groups (37) of at least one battery cell(s), and at least a first (41) and a second (43) battery control circuit, each connected between different groups of battery cells.

6. A battery pack according to claim 5, characterized in that the second battery control circuit (43) is designed to withstand a higher voltage than the first battery control circuit (41).

7. A battery pack according to claim 4, characterized in that the battery pack (33) comprises one or more battery control circuit(s) (41, 43) arranged to divide the battery pack into electrically separate groups (37) of at least one battery cell(s), wherein each group is arranged to supply an output voltage of less than or equal to 60 V.

8. A battery pack according to claim 1, characterized in that the battery pack (33) is adapted to supply electric energy to an electric vehicle (21), wherein the load (23) is an electric motor for propulsion of the vehicle.

9. A battery control device arranged to generate control signals for controlling a battery pack (1, 33), which battery pack comprises at least one battery cell (3, 39) and is arranged to supply an output voltage for feeding electric energy to a load (23) so that the load may perform a function, characterized in that the battery control device (35) is arranged to generate an operate control signal to the battery pack (1, 33) in response to receiving information that the load is to perform its function, which operate control signal induces a battery control circuit (11, 41, 43) connected with at least one battery cell in the battery pack to allow feeding a supplied voltage from the battery cell through the battery control circuit (11,41,43).

10. A battery control device according to claim 9, characterized in that the battery control device (35) is arranged to continuously generate the operate control signal while the load is being operated.

11. A battery control device according to claim 9, characterized in that the battery control device (35) is arranged to generate the operate control signal by supplying a control voltage to the at least one battery control circuit.

12. A battery control device according to claim 9, characterized in that the battery control device (35) is arranged to generate an operate control signal to at least one first battery control circuit (41) and then to generate a second operate control signal to a second battery control circuit (43), which second battery control circuit (43) is designed to withstand a higher voltage than the first battery control circuit (41).

13. A battery control device according to claim 9, characterized in that the battery pack (1, 33) is adapted to supply electric energy to an electric vehicle (21), and the load (23) is an electric motor for propulsion of the vehicle, wherein the battery control device (35) is arranged to generate the operate control signal in response to the electric motor (23) being induced to propulse the vehicle.

14. A device comprising a battery pack comprising at least one battery cell, characterized in that the battery pack (1, 33) is designed according to claim 1 and further comprises a battery control device (35) arranged to generate control signals for controlling the battery pack, characterized in that the battery control device is arranged to generate an operate control signal to the battery pack in response to receiving information that the load is to perform its function, which operate control signal induces the battery control circuit connected with at least one battery cell in the battery pack to allow feeding a supplied voltage from the battery cell through the battery control circuit.

15. A device according to claim 14, characterized in that the device (21) is an electric vehicle and comprises a load (23) comprising an electric motor for propulsion of the vehicle, wherein the battery pack (33) is arranged to supply electric energy to the electric motor, and the battery control device (35) is arranged to generate the operate control signal in response to the electric motor being induced to pro pulse the vehicle.

16. A method of supplying electric energy to a load in order for the load to perform a function, the method comprising
receiving information that the load is to perform its function,
generating an operate control signal in a battery control device,
receiving the operate control signal in a battery pack comprising at least one battery cell arranged to supply a voltage to the load, and
allowing feeding the supply of voltage through a battery control circuit in response to the operate control signal.

17. A battery pack according to claim 2, characterized in that the battery control circuit (11) comprises a semi-conductor device comprising a first connector (13) electrically connected with at least one battery cell, a second connector (15), and a switch control (17) arranged to allow a current between the first and the second connectors when receiving a control voltage from the operate control signal.

18. A battery control device according to claim 10, characterized in that the battery control device (35) is arranged to generate the operate control signal by supplying a control voltage to the at least one battery control circuit.
